(19) United States
(12) Patent Application Publication
(10) Pub. No.: US 2024/0283489 A1
(43) Pub. Date: Aug. 22, 2024

(54) METHOD FOR PERFORMING COOPERATION GROUP INDICATION IN WIRELESS COMMUNICATION SYSTEM FOR MULTI-LINK OPERATION CONTROL, AND ASSOCIATED APPARATUS

(71) Applicant: MEDIATEK INC., Hsin-Chu (TW)

(72) Inventors: Chien-Fang Hsu, Hsinchu City (TW); Hao-Hua Kang, Hsinchu City (TW)

(73) Assignee: MEDIATEK INC., Hsin-Chu (TW)

(21) Appl. No.: 18/419,571

(22) Filed: Jan. 23, 2024

Related U.S. Application Data
(60) Provisional application No. 63/485,267, filed on Feb. 16, 2023.
(60) Provisional application No. 63/486,674, filed on Feb. 24, 2023.

(51) Int. Cl. H04B 7/024; H04W 76/15

(52) U.S. Cl. CPC H04B 7/024; H04W 76/15

(57) ABSTRACT

A method for performing cooperation group (CG) indication in a wireless communication system for multi-link operation (MLO) control and associated apparatus one or more AP devices and one or more non-access-point (non-AP) devices are provided. For example, the wireless communication system may include a non-access-point (non-AP) device and at least one other device such as a first access point (AP) and a second AP, and the non-AP device may be wirelessly linking to the first AP and to the second AP. The method may include: comparing a first CG indicator from the first AP with a second CG indicator from the second AP; and configuring a feature support capability of the non-AP device according to a comparison result of the first CG indicator and the second CG indicator.

### CROSS REFERENCE TO RELATED APPLICATIONS

This application claims the benefit of U.S. Provisional Application No. 63/485,267, filed on Feb. 16, 2023. Further, this application claims the benefit of U.S. Provisional Application No. 63/486,674, filed on Feb. 24, 2023. The contents of these applications are incorporated herein by reference.

### BACKGROUND

The present invention is related to communication control, and more particularly, to a method for performing cooperation group (CG) indication in a wireless communication system for multi-link operation (MLO) control, and associated apparatus such as a wireless transceiver device in the wireless communication system.

According to the related art, a wireless communication device in a wireless communication system may be implemented as a multi-link device (MLD) for communicating with another device via two or more links respectively corresponding to two or more predetermined radio frequency (RF) bands such as the 2.4 gigahertz (GHz) band, the 5 GHz band, etc., in order to utilize wireless media efficiently and increase transmission/reception diversity. For example, the MLD may be arranged to comprise multiple access points (APs) that are collocated within the MLD. Assuming that the MLD may be extended to a greater system with non-collocated APs such as some APs that are not physically collocated at the same place, it seems that there is no proper solution regarding MLO control in the related art for guaranteeing the overall performance, and malfunctions may occur due to incorrect control. Thus, a novel method and associated architecture are needed for solving the problems without introducing any side effect or in a way that is less likely to introduce a side effect.

### SUMMARY

It is an objective of the present invention to provide a method for performing CG indication in a wireless communication system for MLO control, and associated apparatus such as wireless transceiver devices (e.g., one or more AP devices and one or more non-access-point (non-AP) devices) in the wireless communication system, in order to solve the above-mentioned problems.

At least one embodiment of the present invention provides a method for performing CG indication in a wireless communication system for MLO control, where a non-AP device may be wirelessly linking to a first AP and to a second AP. The method may comprise: comparing a first CG indicator from the first AP with a second CG indicator from the second AP; and configuring a feature support capability of the non-AP device according to a comparison result of the first CG indicator and the second CG indicator. For example, the non-AP device may be arranged to parse feature support capabilities in capabilities element fields from the first AP and the second AP respectively before configuring. More particularly, the step of configuring the feature support capability of the non-AP device may comprise selectively enabling or disabling the feature support capability of the non-AP device. Regarding enabling for the case of a same CG, the step of configuring the feature support capability of the non-AP device may comprise enabling the feature support capability of the non-AP device when the comparison result is that the first CG indicator and the second CG indicator belong to the same CG. For example, the first AP and the second AP may be collocated geographically or collocated via a backhaul device. When the parsing result of the parsing operation indicates the feature support capabilities for the same CG are supported, the feature support capability may be enabled. Regarding disabling for the case of different CGs, the step of configuring the feature support capability of the non-AP device may comprise disabling the feature support capability of the non-AP device when the comparison result is that the first CG indicator and the second CG indicator belong to different CGs. For example, when the parsing indicates at least one of the feature support capabilities for different CGs is not supported, the feature support capability may be disabled.

At least one embodiment of the present invention provides a non-AP device for performing CG indication in a wireless communication system such as that mentioned above for MLO control, where the non-AP device may be one of multiple devices within the wireless communication system. The non-AP device may comprise a processing circuit that is arranged to control operations of the non-AP device. The non-AP device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the non-AP device. For example, the aforementioned at least one other device may comprise a first AP and a second AP, and the non-AP device may be wirelessly linking to the first AP and to the second AP. In addition, the non-AP device may be arranged to compare a first CG indicator from the first AP with a second CG indicator from the second AP, and configure a feature support capability of the non-AP device according to a comparison result of the first CG indicator and the second CG indicator. According to some embodiments, the non-AP device may be implemented as a non-AP MLD.

According to some embodiments, the present invention also provides a method for performing CG indication of an AP device in a wireless communication system such as that mentioned above for MLO control. The method may comprise: utilizing at least one communication control circuit within the AP device to carry at least one indicator regarding at least one CG in at least one first communication frame, wherein any indicator among the aforementioned at least one indicator indicates a CG to which a corresponding communication control circuit among the aforementioned at least one communication control circuit belongs; and utilizing the aforementioned at least one communication control circuit to send the aforementioned at least one first communication frame carrying the aforementioned at least one indicator to a non-AP device within the wireless communication system, for notifying the non-AP device of the aforementioned at least one CG to which the aforementioned at least one communication control circuit belongs, to allow the non-AP device to perform the MLO control according to the aforementioned at least one indicator.

According to some embodiments, the present invention also provides an AP device for performing CG indication of the AP device in a wireless communication system for MLO control, where the AP device may be one of multiple devices within the wireless communication system. The AP device may comprise a processing circuit that is arranged to control operations of the AP device. The AP device may further comprise at least one communication control circuit that is coupled to the processing circuit and arranged to perform communication control, where the aforementioned at least one communication control circuit is arranged to perform wireless communication operations with at least one other device among the multiple devices within the wireless communication system for the AP device. For example, the aforementioned at least one other device may comprise a non-AP device. In addition, the aforementioned at least one communication control circuit is arranged to carry at least one indicator regarding at least one CG in at least one first communication frame, wherein any indicator among the aforementioned at least one indicator indicates a CG to which a corresponding communication control circuit among the aforementioned at least one communication control circuit belongs; and the aforementioned at least one communication control circuit is arranged to send the aforementioned at least one first communication frame carrying the aforementioned at least one indicator to the non-AP device within the wireless communication system, for notifying the non-AP device of the aforementioned at least one CG to which the aforementioned at least one communication control circuit belongs, to allow the non-AP device to perform the MLO control according to the aforementioned at least one indicator. According to some embodiments, the AP device may be implemented as an AP MLD, and the non-AP device may be implemented as a non-AP MLD.

It is an advantage of the present invention that, through proper design, the present invention method, as well as the associated apparatus such as the wireless transceiver devices (e.g., the one or more AP devices and the one or more non-AP devices) in the wireless communication system, can perform affiliated AP group indication and adaptively perform service (or feature) support update, and more particularly, control each AP to be affiliated to a group identifier (ID) or at least one group ID, and pause one or more features while a non-AP MLD is connecting to a non-CG, and therefore enhance the overall performance. Additionally, the present invention method and apparatus can solve the related art problems without introducing any side effect or in a way that is less likely to introduce a side effect.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a wireless communication system according to an embodiment of the present invention.

FIG. 2 illustrates a first MLD control scheme for MLOs according to an embodiment of the present invention.

FIG. 3 illustrates a CG-based MLD control scheme of a method for performing CG indication in a wireless communication system for MLO control according to an embodiment of the present invention.

FIG. 4 illustrates an affiliated AP group indication control scheme of the method according to an embodiment of the present invention.

FIG. 5 illustrates a group ID announcement control scheme of the method according to an embodiment of the present invention.

FIG. 6 illustrates some implementation details of the group ID announcement control scheme shown in FIG. 5 according to an embodiment of the present invention.

FIG. 7 illustrates a first service support update announcement control scheme of the method according to an embodiment of the present invention.

FIG. 8 illustrates an Ultra High Reliability (UHR) Capabilities element format involved with the first service support update announcement control scheme shown in FIG. 7 according to an embodiment of the present invention.

FIG. 9 illustrates a second service support update announcement control scheme of the method according to an embodiment of the present invention.

FIG. 10 illustrates a Medium Access Control (MAC) Capabilities Information field format involved with the method according to an embodiment of the present invention.

FIG. 11 illustrates a working flow of the method according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

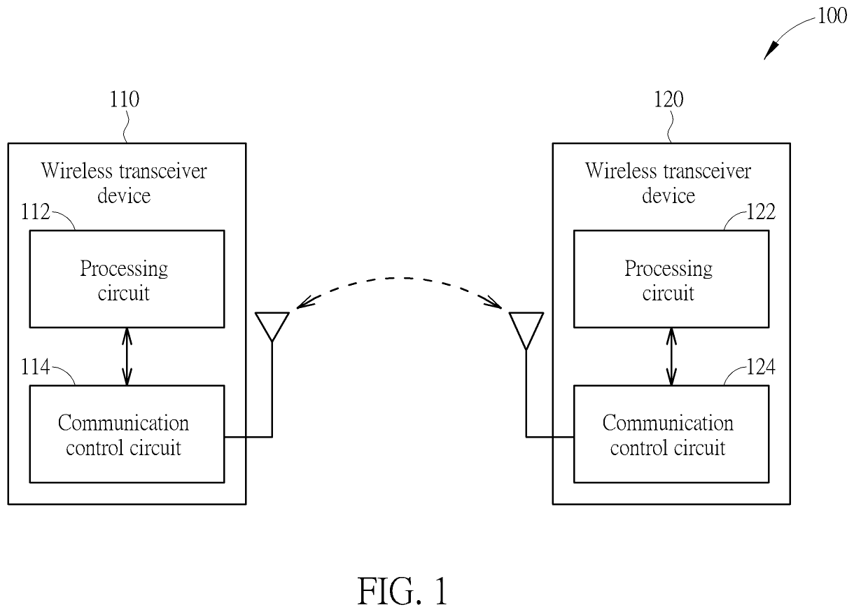

FIG. 1 is a diagram of a wireless communication system 100 according to an embodiment of the present invention. For better comprehension, the wireless communication system 100, as well as any wireless transceiver device #n among multiple wireless transceiver devices #1, . . . and #N therein, may be compatible or backward-compatible to one or more versions of the Institute of Electrical and Electronics Engineers (IEEE) 802.11 standards, but the present invention is not limited thereto. Regarding the multiple wireless transceiver devices #1, . . . and #N within the wireless communication system 100, a wireless transceiver device 110 may represent the wireless transceiver device #1, a wireless transceiver device 120 may represent the wireless transceiver device #2, and the rest may be deduced by analogy. For example, the wireless transceiver device #1 such as the wireless transceiver device 110 may be implemented as an AP device, and another wireless transceiver device among multiple wireless transceiver devices #1, . . . and #N, such as the wireless transceiver device 120, may be implemented as a non-AP station (STA) device, but the present invention is not limited thereto. For another example, both of the wireless transceiver devices #1 and #2 such as the wireless transceiver devices 110 and 120 may be implemented as AP devices, and some other wireless transceiver devices among the multiple wireless transceiver devices #1, . . . and #N may be implemented as non-AP STA devices. For yet another example, both of the wireless transceiver devices #1 and #2 such as the wireless transceiver devices 110 and 120 may be implemented as non-AP STA devices, and some other wireless transceiver devices among the multiple wireless transceiver devices #1, . . . and #N may be implemented as AP devices.

As shown in FIG. 1, the wireless transceiver device 110 may comprise a processing circuit 112, at least one communication control circuit (e.g., one or more communication control circuits), which may be collectively referred to as the communication control circuit 114, and at least one antenna (e.g., one or more antennas) of the communication control circuit 114, and the wireless transceiver device 120 may comprise a processing circuit 122, at least one communication control circuit (e.g., one or more communication control circuits), which may be collectively referred to as the communication control circuit 124, and at least one antenna (e.g., one or more antennas) of the communication control circuit 124. In the architecture shown in FIG. 1, the processing circuit 112 can be arranged to control operations of the wireless transceiver device 110, and the communication control circuit 114 can be arranged to perform communication control, and more particularly, perform wireless communication operations with the network (or at least one other device therein such as the wireless transceiver device 120) for the wireless transceiver device 110. In addition, the processing circuit 122 can be arranged to control operations of the wireless transceiver device 120, and the communication control circuit 124 can be arranged to perform communication control, and more particularly, perform wireless communication operations with the network (or at least one other device therein such as the wireless transceiver device 110) for the wireless transceiver device 120.

According to some embodiments, the processing circuit 112 can be implemented by way of at least one processor/microprocessor, at least one random access memory (RAM), at least one bus, etc., and the communication control circuit 114 can be implemented by way of at least one wireless network control circuit and at least one wired network control circuit, but the present invention is not limited thereto. Examples of the wireless transceiver device 110 may include, but are not limited to: a Wi-Fi router. In addition, the processing circuit 122 can be implemented by way of at least one processor/microprocessor, at least one RAM, at least one bus, etc., and the communication control circuit 124 can be implemented by way of at least one wireless network control circuit, but the present invention is not limited thereto. Examples of the wireless transceiver device 120 may include, but are not limited to: a multifunctional mobile phone, a laptop computer, an all-in-one computer and a wearable device.

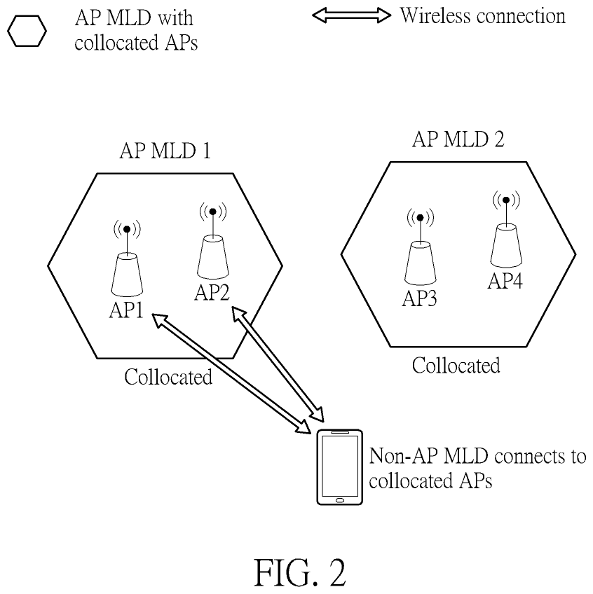

FIG. 2 illustrates a first MLD control scheme for MLOs according to an embodiment of the present invention. The aforementioned any wireless transceiver device #n (e.g., the wireless transceiver device 110) can be implemented as an AP MLD having multiple APs affiliated with the AP MLD, and these APs can co-work closely to utilize multiple wireless media efficiently and to increase transmission/receive diversity. As a result, the overall performance such as throughput and latency can be improved. In general, these APs are co-located in the same place physically, so that the high bandwidth inter-connection and customized interface between the APs can be easily achieved. For example, the wireless communication system 100 may comprise multiple AP MLDs such as the AP MLDs #1 and #2 (respectively labeled “AP MLD 1” and “AP MLD 2” for brevity) that are non-collocated, where the AP MLD #1 may comprise multiple APs such as the APs AP1 and AP2, and the AP MLD #2 may comprise multiple APs such as the APs AP3 and AP4. As shown in FIG. 2, the APs AP1 and AP2 are affiliated to the AP MLD #1 and are collocated within the AP MLD #1, and the APs AP3 and AP4 are affiliated to the AP MLD #2 and are collocated within the AP MLD #2. A non-AP MLD may be arranged to connect to collocated APs such as the APs AP1 and AP2 collocated within the AP MLD #1, in order to perform wireless communication operations via the wireless connections between the non-AP MLD and the collocated APs.

Based on the first MLD control scheme, the AP MLD (e.g., the AP MLD #1) and the non-AP MLD may communicate with each other via two or more links respectively corresponding to two or more predetermined RF bands such as the 2.4 GHz band, the 5 GHz band, etc., in order to utilize wireless media efficiently and increase transmission/reception diversity. However, in a Multi-AP (MAP) system, when extending the AP MLD to include more APs which may not be collocated in the same place, which means they are distributed in multiple places and certain inter-connection exists in either wired or wireless backhauls, the inter-connection may be limited by the backhaul bandwidth and larger latency. For example, the time-constrained features requiring tight timing synchronization may not be supported while the non-AP MLD is connected to non-collocated APs even though they are affiliated to the same AP MLD. As shown in one or more embodiments among the subsequent embodiments, the aforementioned any wireless transceiver device #n (e.g., the wireless transceiver device 110) may be arranged to advertise an indication and corresponding service (or feature) limitations, and update the indication and the corresponding service limitations dynamically while the non-AP MLD is roaming inside the extended AP MLD such as a greater, combined AP MLD formed with at least one portion of APs among all APs of the multiple AP MLDs (e.g., the AP MLDs #1 and #2).

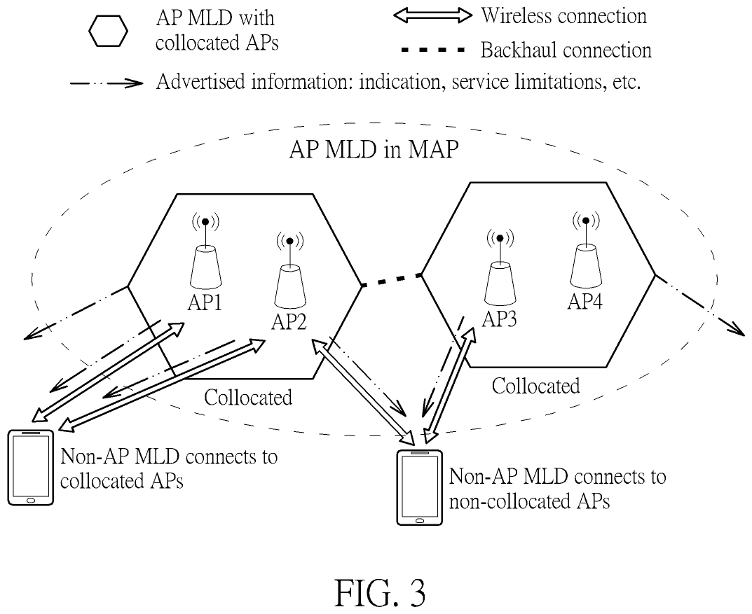

FIG. 3 illustrates a CG-based MLD control scheme of a method for performing CG indication in a wireless communication system (e.g., the wireless communication system 100) for MLO control according to an embodiment of the present invention. The method may be applied to the wireless transceiver device #n such as one of the wireless transceiver devices 110 and 120 for performing CG indication of the wireless transceiver device #n in the wireless communication system 100. Taking the wireless transceiver device 110 as an example of the wireless transceiver device #n, the associated operations of the wireless transceiver device 110 operating according to the method may comprise:
(1) the wireless transceiver device 110 may utilize the aforementioned at least one communication control circuit such as the communication control circuit 114 to carry at least one indicator (e.g., one or more indicators) regarding at least one CG (e.g., one or more CGs) in at least one first communication frame (e.g., one or more first communication frames), where any indicator among the aforementioned at least one indicator may indicate a CG to which a corresponding communication control circuit among the aforementioned at least one communication control circuit belongs; and
(2) the wireless transceiver device 110 may utilize the aforementioned at least one communication control circuit such as the communication control circuit 114 to send the aforementioned at least one first communication frame carrying the aforementioned at least one indicator to another device within the wireless communication system 100, for notifying the other device of the aforementioned at least one CG to which the aforementioned at least one communication control circuit belongs, to allow the other device to perform the MLO control according to the aforementioned at least one indicator;
where the at least one communication control circuit such as the communication control circuit 114 may comprise multiple communication control circuits (e.g., two communication control circuits acting as two APs) for communicating with the other device via multiple links (e.g., two links) respectively corresponding to multiple predetermined RF bands (e.g., two predetermined RF bands) such as the 2.4 GHz band and the 5 GHz band, and the aforementioned at least one indicator may represent at least one group ID of the aforementioned at least one CG to which the aforementioned at least one communication control circuit belongs, but the present invention is not limited thereto. For example, the communication control circuits count of the multiple communication control circuits, the AP count of the APs acted by the multiple communication control circuits, the link count of the multiple links, and the predetermined RF bands count of the multiple predetermined RF bands may vary, and more particularly, the multiple predetermined RF bands may comprise the 2.4 GHz band, the 5 GHz band and the 6 GHz band.

For better comprehension, the wireless transceiver device #n such as the wireless transceiver device 110 may be implemented as a first AP MLD (e.g., the AP MLD #1 mentioned above, labeled “AP MLD 1” in FIG. 2 for brevity), and the first AP MLD may comprise multiple APs such as the APs AP1 and AP2 collocated within the first AP MLD, where the multiple communication control circuits may be arranged to act as the multiple APs such as the APs AP1 and AP2, but the present invention is not limited thereto. For example, the MAP system within the wireless communication system 100 may comprise the multiple AP MLDs such as the first AP MLD (e.g., the AP MLD #1) and a second AP MLD (e.g., the AP MLD #2 mentioned above, labeled “AP MLD 2” in FIG. 2 for brevity), and any AP MLD among the multiple AP MLDs may comprise multiple APs collocated within the aforementioned any AP MLD. Thus, the first AP MLD (e.g., the AP MLD #1) may be one of the multiple AP MLDs (e.g., the AP MLDs #1 and #2). In addition, any AP among the multiple APs (e.g., the APs AP1 and AP2) collocated within the first AP MLD (e.g., the AP MLD #1) and any other AP among multiple other APs (e.g., the APs AP3 and AP4) collocated within another AP MLD (e.g., the AP MLD #2) among the multiple AP MLDs are not physically collocated at a same place.

As shown in FIG. 3, there may be one or more backhaul connections between the first AP MLD (or the APs AP1 and AP2 collocated therein) and the other AP MLD (or the APs AP3 and AP4 collocated therein), and the APs AP1, AP2, AP3 and AP4 may be affiliated to the aforementioned extended AP MLD such as a greater, combined AP MLD formed with all APs of the multiple AP MLDs (labeled “AP MLD in MAP” for brevity). For example, the APs AP1 and AP2 are collocated within the first AP MLD mentioned above, and the APs AP3 and AP4 are collocated within the second AP MLD mentioned above. In addition, a first non-AP MLD may be arranged to connect to some collocated APs such as the APs AP1 and AP2, while a second non-AP MLD may be arranged to connect to some non-collocated APs such as the APs AP2 and AP3. Based on the CG-based MLD control scheme, the wireless transceiver device #n (e.g., the wireless transceiver device 110) such as the first AP MLD may be arranged to send advertised information such as the indication (e.g., the aforementioned at least one indicator), the corresponding service (or feature) limitations, etc. to any non-AP MLD (e.g., the first non-AP MLD and the second non-AP MLD) in the wireless communication system 100, and update the indication and the corresponding service limitations dynamically while the aforementioned any non-AP MLD is roaming among the APs AP1, AP2, AP3 and AP4 affiliated to the extended AP MLD (or “the AP MLD in MAP”).

Regarding a non-AP device (e.g., the aforementioned any non-AP MLD) that is wirelessly linking to a first AP (e.g., one of the APs AP1, AP2, AP3 and AP4) and to a second AP (e.g., another of the APs AP1, AP2, AP3 and AP4), the non-AP device may operate according to the method, and the associated operations of the non-AP device may comprise:
(1) the non-AP device (or the communication control circuit therein) may compare a first CG indicator from the first AP with a second CG indicator from the second AP; and
(2) the non-AP device (or the communication control circuit therein) may configure a feature support capability of the non-AP device according to a comparison result of the first CG indicator and the second CG indicator;
where the first CG indicator and the second CG indicator may be represented by at least one group ID (e.g., the aforementioned at least one group ID of the aforementioned at least one CG). In addition, the operation of configuring the feature support capability of the non-AP device may comprise selectively enabling or disabling the feature support capability of the non-AP device. For example, the operation of configuring the feature support capability of the non-AP device may comprise enabling the feature support capability of the non-AP device when the comparison result is that the first CG indicator and the second CG indicator belong to a same CG. More particularly, the first AP and the second AP may be collocated geographically or collocated via a backhaul device. Before the operation of configuring the feature support capability of the non-AP device, the non-AP device may parse feature support capabilities in capabilities element fields from the first AP and the second AP (e.g., the capabilities element field of a first communication frame from the first AP and the capabilities element field of a second communication frame from the second AP) respectively. When the parsing result of the parsing operation indicates that the feature support capabilities for the same CG are supported, the feature support capability may be enabled. For another example, the operation of configuring the feature support capability of the non-AP device may comprise disabling the feature support capability of the non-AP device when the comparison result is that the first CG indicator and the second CG indicator belong to different CGs. Before the operation of configuring the feature support capability of the non-AP device, the non-AP device may parse the feature support capabilities in the capabilities element fields from the first AP and the second AP (e.g., the capabilities element field of the first communication frame from the first AP and the capabilities element field of the second communication frame from the second AP) respectively. When the parsing result of the parsing operation indicates that at least one of the feature support capabilities for different CGs is not supported, the feature support capability may be disabled. According to some embodiments, the first CG indicator and the second CG indicator may be represented by at least one AP multi-link device identifier (AP MLD ID) or one AP MLD MAC address.

In the operation of configuring the feature support capability of the non-AP device, the feature support capability may represent any feature support capability among multiple feature support capabilities of the non-AP device. As any AP and the non-AP device (e.g., the aforementioned any non-AP MLD) in the wireless communication system 100 may have their own feature support capabilities, when the non-AP device is wirelessly linking to different APs in the wireless communication system 100, the non-AP device may compare CG indicators from the aforementioned different APs to generate at least one comparison result, in order to dynamically configure the aforementioned any feature support capability according to the aforementioned at least one comparison result of these CG indicators from the aforementioned different APs, and therefore enhance the overall performance. For example, the operation of comparing the first CG indicator from the first AP with the second CG indicator from the second AP may further comprise comparing multiple first CG indicators with at least one second CG indicator, and the operation of configuring the feature support capability of the non-AP device may comprise configuring the feature support capability of the non-AP device when at least one of the multiple first CG indicators and the at least one second CG indicator belong to the same CG. As a result, at any moment in the runtime of the non-AP device, the non-AP device may enable the associate feature support capabilities as many as possible and perform communication operations with the associate feature support capabilities, in order to achieve the best performance at the aforementioned any moment.

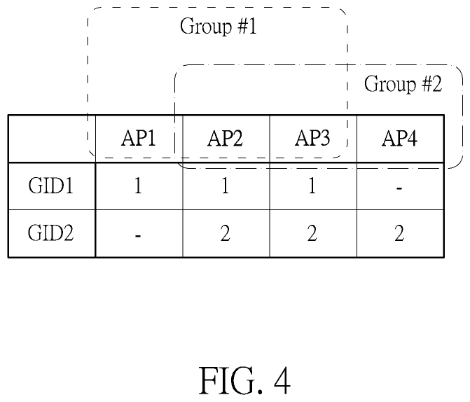

FIG. 4 illustrates an affiliated AP group indication control scheme of the method according to an embodiment of the present invention. The aforementioned at least one CG may represent at least one predetermined CG among multiple predetermined CGs, where any communication control circuit among the multiple communication control circuits may belong to one or more predetermined CGs among the multiple predetermined CGs. For example, the multiple predetermined CGs may comprise the predetermined CGs #1 and #2 (respectively labeled “Group #1” and “Group #2” for brevity), where the predetermined CG #1 may comprise the APs AP1, AP2 and AP3, and the predetermined CG #2 may comprise the APs AP2, AP3 and AP4, but the present invention is not limited thereto. According to some embodiments, the multiple predetermined CGs and/or the predetermined CGs count of the multiple predetermined CGs may vary. In addition, each AP among the multiple APs collocated within the aforementioned any AP MLD may be affiliated to at least one group ID (e.g., one or more group IDs), and the aforementioned any indicator among the aforementioned at least one indicator may represent a group ID of the CG to which the corresponding communication control circuit (or the corresponding AP acted by the corresponding communication control circuit) belongs. For example, the CG may represent a collocated group such as a group of collocated APs, but the present invention is not limited thereto. For another example, the CG may represent a virtual collocated group such as a group of APs with powerful backhaul so that the interconnection is unlimited even physically they are not collocated. No matter whether the CG may represent the collocated group or the virtual collocated group, the CG should be transparent to the aforementioned any non-AP MLD (e.g., the first non-AP MLD and the second non-AP MLD).

Based on the affiliated AP group indication control scheme, any two APs with a same group ID assigned among all APs within the MAP system may belong to a same CG, so the APs with the same group ID assigned may be considered as a CG. For example, among the APs AP2, AP3 and AP4 shown in FIG. 4, the APs AP1, AP2 and AP3 with the same group ID GID1 may be considered as the CG #1, and the APs AP2, AP3 and AP4 with the same group ID GID2 may be considered as the CG #2. More particularly, while the non-AP MLD is assigned to the APs with the same group ID, it is considered connecting to a CG. Taking the CG configuration shown in FIG. 4 as an example, the non-AP MLD connections to the APs AP1, AP2 and AP3 may be considered as the connections to the CG #1. In addition, any two APs with different group IDs assigned among all APs within the MAP system may belong to a non-CG, where a second services support (or second features support) of the non-CG may be different from a first services support (or first features support) of the CG. For example, among the APs AP2, AP3 and AP4 shown in FIG. 4, any combination of APs with different group IDs (e.g., the group IDs GID1 and GID2) may be considered as a non-CG. More particularly, while the non-AP MLD is connected to the APs with different group IDs, it is considered connecting to a non-CG, where the services/features support of the non-CG can be different from the case of connecting to a CG. Taking the CG configuration shown in FIG. 4 as an example, the non-AP MLD connections to the APs AP1, AP2 and AP4 may be considered as the connections to the non-CG.

The wireless transceiver device #n (e.g., the wireless transceiver device 110) such as the first AP MLD may be arranged to advertise a service difference (or feature difference) between the second services support and the first services support, and more particularly, advertise the service difference with an announcement in a second communication frame sent by the first AP MLD or by any AP among the multiple APs collocated within the first AP MLD, for guiding the MLO control on the other device such as the non-AP MLD, where the second communication frame may be selected from a set of predetermined communication frames, and the set of predetermined communication frames may comprise a beacon frame, a probe response frame and any other frames such as action frames. In addition, the first AP MLD may advertise the service difference with the announcement in the second communication frame, in either a regular broadcast manner or a unicast manner, for guiding the MLO control on the other device such as the non-AP MLD while at least one connection changes between the CG and the non-CG. For example, the announcement can be regular broadcast by beacon or be unicast to the non-AP MLD while the aforementioned at least one connection changes between the CG and non-CG.

Regarding the service/feature support update, as the support of certain feature(s) may pause while a non-AP MLD connects to a non-CG, the wireless transceiver device #n such as the first AP MLD may advertise any service difference, to allow the non-AP MLD to operate properly without introducing incorrect MLO control, and therefore prevent malfunctions, and the associated examples may comprise:
(1) the non-simultaneous transmit and receive (NSTR) support: while an NSTR non-AP MLD connects to a non-CG, the NSTR service from the AP MLD may pause until the NSTR non-MLD connects to a CG, for example, the AP MLD may encourage or instruct an NSTR non-AP MLD to connect to a CG, even in a situation where certain parameters (e.g., the signal strength and the load balance) for the case of connecting to the CG are not as good as that for the case of connecting to a non-CG;
(2) the Enhanced Multi-Link Single Radio (EMLSR) support: while a non-AP MLD with EMLSR links connects to a non-CG, the EMLSR links could be in different group of the AP MLD, and the AP MLD may instruct the non-AP MLD to change the EMLSR mode, for example, the non-AP MLD may need to change the mode spontaneously if the EMLSR support from the AP MLD is disabled; and
(3) the AP assisted request (AAR) support which is used for AP-assisted medium synchronization recovery, similar to NSTR support, AAR support is paused while the non-AP MLD connects to a non-CG;
but the present invention is not limited thereto.

TABLE 1

| | Subelement ID | Length | STA Control | STA Info |
|---|---|---|---|---|
| Size | 1 | 1 | 2 | variable |
| (Octets) | | | | |

Table 1 illustrates an example of a Per-STA Profile subelement (or sub-element) for a Basic Multi-Link element, where the Per-STA Profile subelement may comprise a Subelement ID field, a Length field, a STA Control field and a STA Information (Info) field, for carrying a Subelement ID, a length, STA control information and STA information, respectively, but the present invention is not limited thereto. In some examples, the format of the Per-STA Profile subelement shown in Table1, the fields thereof and/or the filed count of the fields may vary.

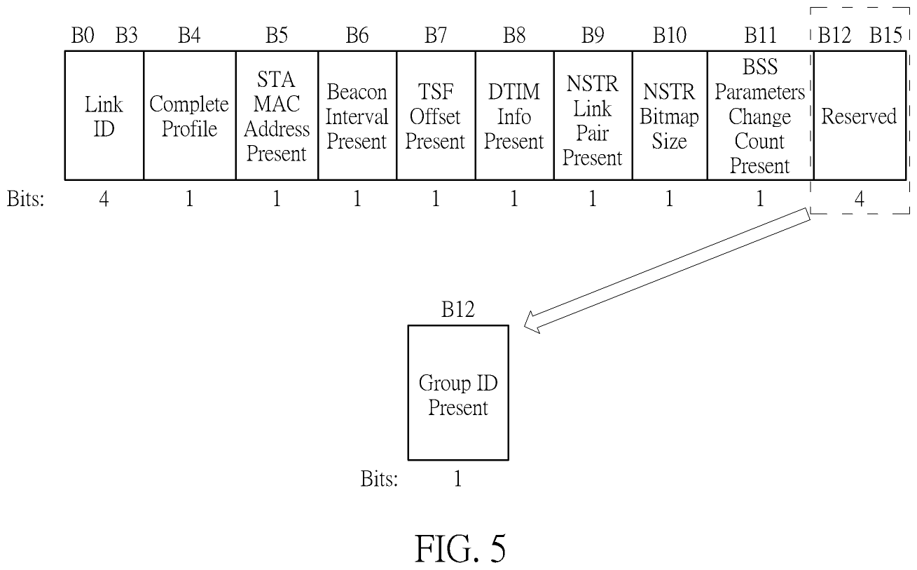

FIG. 5 illustrates a group ID announcement control scheme of the method according to an embodiment of the present invention. Regarding the group indicator (or the group ID), the wireless transceiver device #n such as the first AP MLD may use a current communication frame (e.g., any of the aforementioned at least one first communication frame) to notify the other device (e.g., the non-AP MLD) of:
(a) whether any group ID is present in the current communication frame; and
(b) the group ID(s), for the case that the aforementioned any group ID is present in the current communication frame;
where the current communication frame may be implemented by way of various types of communication frame such as the beacon frames, the probe response frames, the action frames, etc., but the present invention is not limited thereto. For example, the aforementioned any indicator among the aforementioned at least one indicator may represent the group ID of the CG to which the corresponding communication control circuit (or the corresponding AP acted by the corresponding communication control circuit) belongs, and any first communication frame among the aforementioned at least one first communication frame may comprise the Basic Multi-Link element conforming to a first predetermined format (e.g., the STA Control field format of the Basic Multi-Link element), and multiple fields of the first predetermined format may comprise: (B0-B3) a Link ID field, for carrying a Link ID;
(B4) a Complete Profile field, for carrying a Complete Profile indication;
(B5) a STA MAC Address Present field, for carrying a present indicator for indicating whether a STA MAC address is present in the Basic Multi-Link element;
(B6) a Beacon Interval Present field, for carrying a present indicator for indicating whether a beacon interval is present in the Basic Multi-Link element;
(B7) a Timing Synchronization Function (TSF) Offset Present field, for carrying a present indicator for indicating whether a TSF offset is present in the Basic Multi-Link element;
(B8) a Delivery Traffic Indication Message (DTIM) Information (Info) Present field, for carrying a present indicator for indicating whether DTIM information is present in the Basic Multi-Link element;
(B9) a NSTR Link Pair Present field, for carrying a present indicator for indicating whether a NSTR indication bitmap is present in the Basic Multi-Link element;
(B10) a NSTR Bitmap Size field, for carrying a NSTR bitmap size indicator for indicating a NSTR bitmap size of the STR indication bitmap;
(B11) a Basic Service Set (BSS) Parameters Change Count Present field, for carrying a present indicator for indicating whether a BSS parameters change count is present in the Basic Multi-Link element; and
(B12) a Group ID Present field, for carrying a present indicator for indicating whether any group ID is present in the Basic Multi-Link element;
where the bit B12 of the previously reserved bits B12-B15 (labeled “Reserved” for brevity) among all bits B0-B15 of the first predetermined format shown in FIG. 5 may be used as the Group ID Present field, but the present invention is not limited thereto. In some examples, any other bit of the previously reserved bits B12-B15 may be used as the Group ID Present field. According to some embodiments, the current link ID indication in the STA Control field may vary. Based on the group ID announcement control scheme, the first AP MLD may set a new field at any bit of the previously reserved bits B12-B15 in the Multi-Link element in addition to the Link ID (e.g., the current Link ID indication in the STA Control field as shown in the upper half part of FIG. 5).

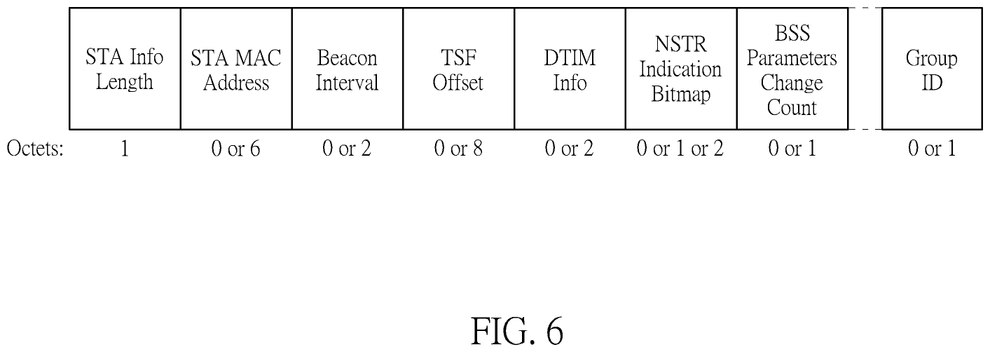

FIG. 6 illustrates some implementation details of the group ID announcement control scheme shown in FIG. 5 according to an embodiment of the present invention. As there are the STA Control field and the STA Info field as shown in Table 1, the Basic Multi-Link element may further conform to a second predetermined format (e.g., the STA Info field format of the Basic Multi-Link element), and multiple fields of the second predetermined format may comprise:
(1) a STA Information (Info) Length field, for carrying a STA Info length of the STA Info field;
(2) a STA MAC Address field, for selectively carrying the STA MAC address according to the present indicator of the STA MAC Address Present field shown in FIG. 5, for example, if this present indicator at the bit B5 shown in FIG. 5 is equal to 1, the STA MAC Address field may have a size of 6 octets for carrying the STA MAC address, otherwise, the size of the STA MAC Address field is set as zero;
(3) a Beacon Interval field, for selectively carrying the beacon interval according to the present indicator of the Beacon Interval Present field shown in FIG. 5, for example, if this present indicator at the bit B6 shown in FIG. 5 is equal to 1, the Beacon Interval field may have a size of 2 octets for carrying the beacon interval, otherwise, the size of the Beacon Interval field is set as zero;
(4) a TSF Offset field, for selectively carrying the TSF offset according to the present indicator of the TSF Offset Present field shown in FIG. 5, for example, if this present indicator at the bit B7 shown in FIG. 5 is equal to 1, the TSF Offset field may have a size of 8 octets for carrying the TSF offset, otherwise, the size of the TSF Offset field is set as zero;
(5) a DTIM Information (Info) field, for selectively carrying the DTIM information according to the present indicator of the DTIM Info Present field shown in FIG. 5, for example, if this present indicator at the bit B8 shown in FIG. 5 is equal to 1, the DTIM Info field may have a size of 2 octets for carrying the DTIM information, otherwise, the size of the DTIM Info field is set as zero;
(6) a NSTR Indication Bitmap field, for selectively carrying the NSTR indication bitmap according to the present indicator of the NSTR Link Pair Present field shown in FIG. 5, for example, if this present indicator at the bit B9 shown in FIG. 5 is equal to 1, the NSTR Indication Bitmap field may have a size of 1 or 2 octets, depending on the NSTR bitmap size indicator, for carrying the NSTR indication bitmap, otherwise, the size of the NSTR Indication Bitmap field is set as zero;
(7) a BSS Parameters Change Count field, for selectively carrying the BSS parameters change count according to the present indicator of the BSS Parameters Change Count Present field shown in FIG. 5, for example, if this present indicator at the bit B11 shown in FIG. 5 is equal to 1, the BSS Parameters Change Count field may have a size of 1 octet for carrying the BSS parameters change count, otherwise, the size of the BSS Parameters Change Count field is set as zero; and
(8) a Group ID field, for selectively carrying one or more group IDs according to the present indicator of the Group ID Present field shown in FIG. 5, for example, if this present indicator at the bit B12 shown in FIG. 5 is equal to 1, the Group ID field may have a size of 1 octet for carrying the one or more group IDs, otherwise, the size of the Group ID field is set as zero;
where the bit B12 of the previously reserved bits B12-B15 shown in FIG. 5 may be used as the Group ID Present field, and the Group ID field may be the next field of the BSS Parameters Change Count field, but the present invention is not limited thereto. In some examples, any other bit of the previously reserved bits B12-B15 may be used as the Group ID Present field, and the Group ID field may be a corresponding subsequent field among at least one subsequent field (e.g., one or more subsequent fields) coming after the BSS Parameters Change Count field. Based on the group ID announcement control scheme, the wireless transceiver device #n such as the first AP MLD may add a new field to indicate the group ID(s), and the APs with the same group ID (e.g., the APs of the same group or the same CG) may be considered as collocated, for example, no matter whether these APs are collocated at the same place physically. In addition, multiple group IDs are allowed to be assigned to one AP.

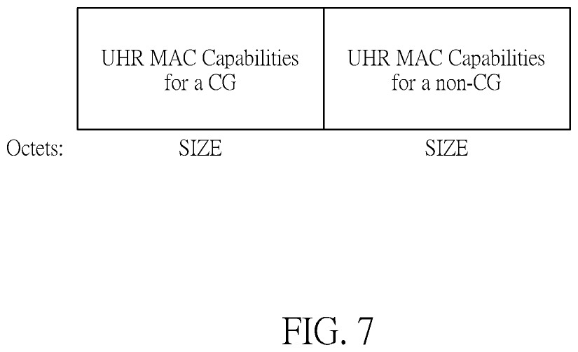

FIG. 7 illustrates a first service support update announcement control scheme of the method according to an embodiment of the present invention. The wireless transceiver device #n such as the first AP MLD may be arranged to advertise the service difference between the second services support of the non-CG and the first services support of the CG with the announcement in the second communication frame, for guiding the MLO control on the other device such as the non-AP MLD. More particularly, the second communication frame may comprise a first capabilities element and a second capabilities element, for indicating the first services support and the second services support, respectively. The first capabilities element and the second capabilities element may be implemented as a first subfield and a second subfield of a UHR Capabilities element, respectively. Taking the MAC Capabilities as an example, the first AP MLD may carry the UHR MAC Capabilities for a CG in the first subfield of the UHR Capabilities element, and carry the UHR MAC Capabilities for a non-CG in the second subfield of the UHR Capabilities element, where each capabilities element among the first capabilities element and the second capabilities element may conform to another predetermined format such as the UHR Capabilities element format. As shown in FIG. 7, the first subfield and the second subfield of the UHR Capabilities element may have a same Subfield Size (labeled “SIZE” for brevity), which may be measured in unit of octets. Similarly, taking the Physical Layer (PHY) Capabilities as an example, the first AP MLD may carry the UHR PHY Capabilities for the CG in the first subfield of the UHR Capabilities element, and carry the UHR PHY Capabilities for a non-CG in the second subfield of the UHR Capabilities element. In addition, the first services support indicated by the first capabilities element and the second services support indicated by the second capabilities element are typically different from each other.

Based on the first service support update announcement control scheme, two sets of service support indications may be carried in the second communication frame (e.g., a beacon frame or a probe response frame), where one set may be applied to the connection to the CG while the other set may be applied to the connection the non-CG, and the respective service supports of the two sets are typically different. More particularly, while a non-AP MLD is roaming from one AP to another AP, the non-AP MLD may have to check the other AP's group ID to decide which set to be used. For example, if one AP has a different group ID which is different from the group ID of one of the other APs, the non-CG capabilities set may be used; otherwise, the CG capabilities set may be used.

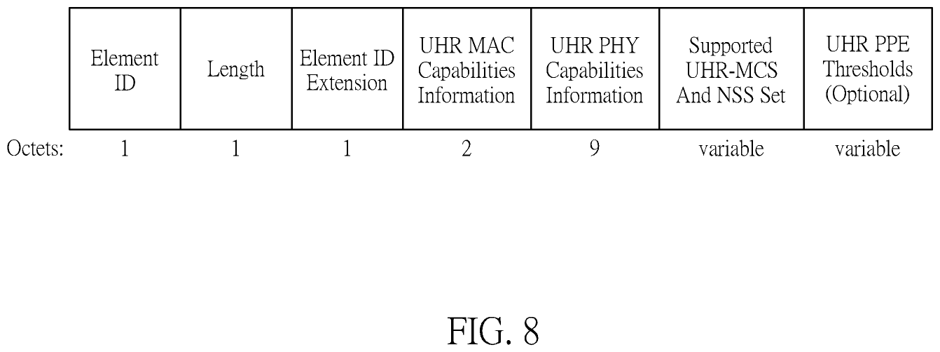

FIG. 8 illustrates an UHR Capabilities element format involved with the first service support update announcement control scheme shown in FIG. 7 according to an embodiment of the present invention. For example, the wireless transceiver device #n such as the first AP MLD may carry two capabilities elements for MAC services in the second communication frame such as the beacon frame, for being sent out to advertise the service difference between the second services support of the non-CG and the first services support of the CG. As shown in FIG. 8, multiple fields of the UHR Capabilities element format may comprise:
(1) an Element ID field, for carrying an Element ID;
(2) a Length field, for carrying a length of the UHR Capabilities element;
(3) an Element ID Extension field, for carrying Element ID extension information;
(4) a UHR MAC Capabilities Information field, for carrying UHR MAC Capabilities information;
(5) a UHR PHY Capabilities Information field, for carrying UHR PHY Capabilities information;
(6) a Supported UHR-Modulation and Coding Scheme (MCS) And Number of Spatial Streams (NSS) Set field, for carrying UHR-MCS and NSS Set information; and
(7) a UHR Padding and Physical Layer Packet Extension (PPE) Thresholds field, for carrying UHR PPE thresholds, where the UHR PPE Thresholds field may be optional;
where the UHR PPE Thresholds field may be optional, but the present invention is not limited thereto. In some examples, the UHR Capabilities element format may vary.

Nowadays in each generation of Wi-Fi standard previously proposed, one set of capabilities (either MAC or PHY) is used (see EHT capabilities element as an example). Based on the first service support update announcement control scheme, a new Capabilities element such as the new UHR Capabilities element can have two sets of MAC capabilities, in order to enhance the MLO control in the MAP system, and therefore improve the overall performance. According to some embodiments, using only one capabilities set can be optional while the AP MLD has no such capabilities difference.

When operating according to the first service support update announcement control scheme, the wireless transceiver device #n such as the first AP MLD may be arranged to use a single-bit support indication (e.g., a support indication having a single bit) in any field among multiple fields of the other predetermined format such as the UHR Capabilities element format to indicate whether a corresponding service (e.g., the service corresponding to the aforementioned any field) is supported, where the single-bit support indication being equal to a first logical value such as 1 may indicate that the corresponding service is supported, and the single-bit support indication being equal to a second logical value such as 0 may indicate that the corresponding service is not supported, but the present invention is not limited thereto. In some examples, the first AP MLD may be arranged to carry a first support indication in a first field among multiple fields of the other predetermined format such as the UHR Capabilities element format, for indicating whether a first service is supported and selectively indicating one or more extra conditions to apply the first service. More particularly, the first AP MLD may set the support (or capability) indication with extra conditions to apply, using a 2-bit NSTR support field as an example, as follows:
(1) NSTR support=3: reserved;
(2) NSTR support=2: support only when connected APs are CG;
(3) NSTR support=1: support for all connected AP regardless they are CG or non-CG; and
(4) NSTR support=0: not support;
where the non-AP MLD may need to check the connected APs' CG status and do the corresponding service availability check.

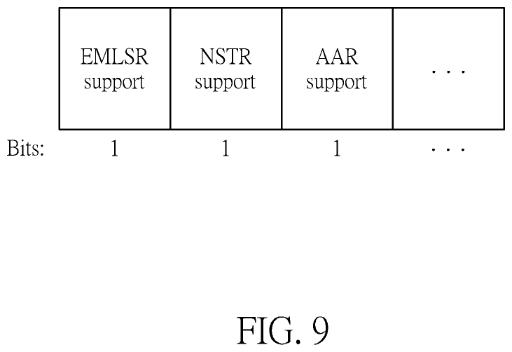

FIG. 9 illustrates a second service support update announcement control scheme of the method according to an embodiment of the present invention. The wireless transceiver device #n such as the first AP MLD may be arranged to carry at least one second support indication in the second communication frame, for announcing at least one service support change of at least one service support. More particularly, the wireless transceiver device #n such as the first AP MLD (or any AP therein) may use the second communication frame to announce the aforementioned at least one service support change, with the aforementioned at least one second support indication therein indicating which service support is enabled or disabled, while any predetermined condition among multiple predetermined conditions are met, and the multiple predetermined conditions may comprise:
(1) a new connection to a non-CG happens while a new connection to a CG happens, for example, for the case of roaming;
(2) the extended AP MLD (or the first AP MLD) re-configures its affiliated APs, for example, for the case of AP MLD reconfiguration; and
(3) the non-AP STA creates or removes a connection to an affiliated AP, for example, for the case of link addition or the case of link deletion;
but the present invention is not limited thereto. In some examples, the multiple predetermined conditions may vary. In addition, the frame can be a unicast action frame to the non-AP MLD, and the contents can be carried in an element or in a field in the frame body.

In comparison with the example using the whole of the new UHR capabilities element according to the first service support update announcement control scheme, the first AP MLD operating according to the second service support update announcement control scheme may use only a portion of the new UHR capabilities element as updated support setting for being unicasted to the non-AP MLD, for applying specific support change(s) only. For example, the first AP MLD may carries the service support(s) to be updated and the updated support indication in the second communication frame, and the non-AP MLD may use the value (e.g., the value of the aforementioned at least one second support indication) received via the second communication frame to update the value set by the previously received beacon/probe response frames, where the other service support(s) may remain the same. As shown in FIG. 9, the aforementioned at least one second support indication may comprise:
(1) the EMLSR Support indication of the EMLSR service, for indicating whether the EMLSR service is supported;
(2) the NSTR support indication of the NSTR service, for indicating whether the NSTR service is supported; and
(3) the AAR support indication of the AAR service, for indicating whether the AAR service is supported;
where specific service support(s) to be updated and the corresponding value(s) may be carried by the aforementioned at least one second support indication such as that shown in FIG. 9, and the first AP MLD may notify the non-AP MLD of the support changes by using the second support indications shown in FIG. 9, but the present invention is not limited thereto. In some examples, the aforementioned at least one second support indication may vary.

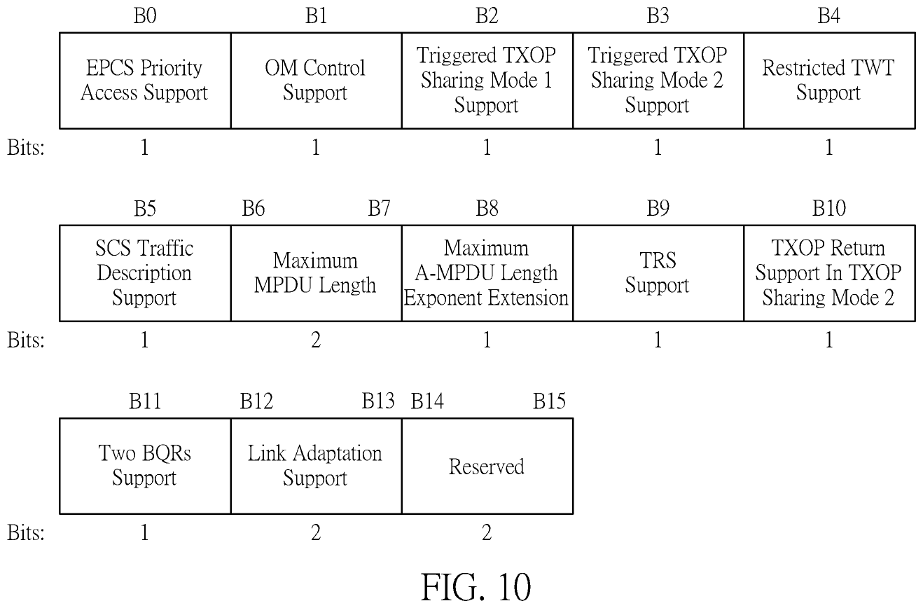

FIG. 10 illustrates a MAC Capabilities Information field format involved with the method according to an embodiment of the present invention. For example, the MAC Capabilities Information field (e.g., the UHR MAC Capabilities Information field) may conform to the MAC Capabilities Information field format shown in FIG. 10, and multiple fields of the MAC Capabilities Information field format may comprise: an EPCS Priority Access Support field, an OM Control Support field, a Triggered TXOP Sharing Mode 1 Support field, a Triggered TXOP Sharing Mode 2 Support field, a Restricted TWT Support field, a SCS Traffic Description Support field, a Maximum MPDU Length field, a Maximum A-MPDU Length Exponent Extension field, a TRS Support field, a TXOP Return Support In TXOP Sharing Mode 2 field, a Two BQRs Support field, a Link Adaptation Support field, where the field names of the fields as shown in FIG. 10 may indicate the corresponding services and/or the corresponding service supports, respectively, but the present invention is not limited thereto. In some examples, the MAC Capabilities Information field format may vary.

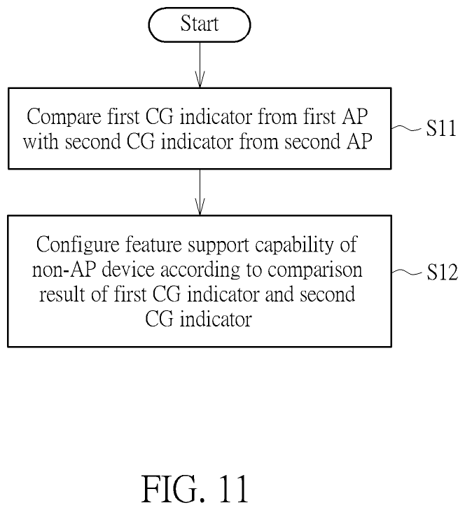

FIG. 11 illustrates a working flow of the method according to an embodiment of the present invention. For example, the aforementioned any wireless transceiver device #n such as the wireless transceiver device 110 may be implemented as the first AP MLD, and another wireless transceiver device #n′ such as the wireless transceiver device 120 may be implemented as the non-AP device (e.g., the aforementioned any non-AP MLD), but the present invention is not limited thereto.

In Step S11, the non-AP device (or the communication control circuit therein) may compare the first CG indicator from the first AP with the second CG indicator from the second AP.

In Step S12, the non-AP device (or the communication control circuit therein) may configure the feature support capability of the non-AP device according to the comparison result of the first CG indicator and the second CG indicator.

For example, the first CG indicator may be represented by a first AP MLD ID, and the second CG indicator may be represented by a second AP MLD ID. The non-AP device (or the communication control circuit therein) may compare the first AP MLD ID and the second AP MLD ID in Step S11 to generate a comparison result of the first AP MLD ID and the second AP MLD ID to be the comparison result mentioned in Step S12. For another example, the first CG indicator may be represented by a first AP MLD MAC address, and the second CG indicator may be represented by a second AP MLD MAC address. The non-AP device (or the communication control circuit therein) may compare the first AP MLD MAC address and the second AP MLD MAC address in Step S11 to generate a comparison result of the first AP MLD MAC address and the second AP MLD MAC address to be the comparison result mentioned in Step S12. For brevity, similar descriptions for this embodiment are not repeated in detail here.

For better comprehension, the method may be illustrated with the working flow shown in FIG. 11, but the present invention is not limited thereto. According to some embodiments, one or more steps may be added, deleted, or changed in the working flow shown in FIG. 11. For example, in Step S11, when the non-AP device is wirelessly linking to different APs in the wireless communication system 100, the non-AP device may compare the CG indicators from the aforementioned different APs to generate at least one comparison result; and in Step S12, the non-AP device may dynamically configure any feature support capability among the multiple feature support capabilities of the non-AP device according to the aforementioned at least one comparison result of these CG indicators from the aforementioned different APs. In addition, the non-AP device may execute the operations of Steps S11 and S12 in multiple iterations, and therefore another arrow pointing to Step S11 from Step S12 may be illustrated in the working flow shown in FIG. 11, for indicating that Step S11 may be re-entered after the execution of Step S12. For brevity, similar descriptions for these embodiments are not repeated in detail here.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for performing cooperation group (CG) indication in a wireless communication system for multi-link operation (MLO) control, wherein a non-access-point (non-AP) device is wirelessly linking to a first access point (AP) and to a second AP, the method comprising:
comparing a first CG indicator from the first AP with a second CG indicator from the second AP; and
configuring a feature support capability of the non-AP device according to a comparison result of the first CG indicator and the second CG indicator.

2. The method of claim 1, wherein the first CG indicator and the second CG indicator are represented by at least one group identifier (ID).

3. The method of claim 1, wherein the configuring the feature support capability of the non-AP device comprises enabling the feature support capability of the non-AP device when the comparison result is that the first CG indicator and the second CG indicator belong to a same CG.

4. The method of claim 3, wherein the first AP and the second AP are collocated geographically or collocated via a backhaul device.

5. The method of claim 3, further comprising:
parsing feature support capabilities in capabilities element fields from the first AP and the second AP respectively before configuring, wherein when the parsing indicates the feature support capabilities for the same CG are supported, the feature support capability is enabled.

6. The method of claim 1, wherein the configuring the feature support capability of the non-AP device comprises disabling the feature support capability of the non-AP device when the comparison result is that the first CG indicator and the second CG indicator belong to different CGs.

7. The method of claim 6, further comprising:
parsing feature support capabilities in capabilities element fields from the first AP and the second AP respectively before configuring, wherein when the parsing indicates at least one of the feature support capabilities for different CGs is not supported, the feature support capability is disabled.

8. The method of claim 1, wherein the first CG indicator and the second CG indicator are represented by at least one AP multi-link device identifier (AP MLD ID) or one AP MLD medium access control (MAC) address.

9. The method of claim 1, wherein the comparing further comprises comparing multiple first CG indicators with at least one second CG indicator, and wherein the configuring step comprises configuring the feature support capability of the non-AP device when at least one of the multiple first CG indicators and the at least one second CG indicator belong to the same CG.

10. A non-access-point (non-AP) device, for performing cooperation group (CG) indication in a wireless communication system for multi-link operation (MLO) control, the non-AP device comprising:
a processing circuit, arranged to control operations of the non-AP device; and
at least one communication control circuit, coupled to the processing circuit, arranged to perform communication control, wherein the at least one communication control circuit is arranged to perform wireless communication operations with at least one other device within the wireless communication system for the non-AP device, wherein the at least one other device comprises a first AP and a second AP, and the non-AP device is wirelessly linking to the first AP and to the second AP;
wherein:
the non-AP device is arranged to compare a first CG indicator from the first AP with a second CG indicator from the second AP; and
the non-AP device is arranged to configure a feature support capability of the non-AP device according to a comparison result of the first CG indicator and the second CG indicator.

11. The non-AP device of claim 10, wherein the non-AP device is implemented as a non-AP multi-link device (MLD).

12. The non-AP device of claim 10, wherein the non-AP device is configured to enable the feature support capability of the non-AP device when a comparison result of the first CG indicator and the second CG indicator is that the first CG indicator and the second CG indicator belong to a same CG.

13. The non-AP device of claim 12, wherein before configuring the feature support capability of the non-AP device, the non-AP device is arranged to parse feature support capabilities in capabilities element fields from the first AP and the second AP respectively, wherein when the parsing indicates the feature support capabilities for the same CG are supported, the feature support capability of the non-AP device is enabled.

14. The non-AP device of claim 10, wherein the non-AP device is configured to disable the feature support capability of the non-AP device when a comparison result of the first CG indicator and the second CG indicator is that the first CG indicator and the second CG indicator belong to different CGs.

15. The non-AP device of claim 14, wherein before configuring the feature support capability of the non-AP device, the non-AP device is arranged to parse feature support capabilities in capabilities element fields from the first AP and the second AP respectively, wherein when the parsing indicates at least one of the feature support capabilities for different CGs is not supported, the feature support capability of the non-AP device is disabled.

16. The non-AP device of claim 10, wherein the non-AP device is further arranged to compare multiple first CG indicators with at least one second CG indicator, and wherein the non-AP device is arranged to configure the feature support capability of the non-AP device when at least one of the multiple first CG indicators and the at least one second CG indicator belong to the same CG.
